(19) United States
(12) Patent Application Publication
(10) Pub. No.: US 2009/0021887 A1
(43) Pub. Date: Jan. 22, 2009

(54) MULTI-LAYER CAPACITOR AND WIRING BOARD HAVING A BUILT-IN CAPACITOR

(75) Inventors: Kousuke Nakamura, Gunma (JP); Takashi Masuda, Gunma (JP)

Correspondence Address: KNOBBE MARTENS OLSON & BEAR LLP, 2040 MAIN STREET, FOURTEENTH FLOOR, IRVINE, CA, 92614, US

(73) Assignee: Taiyo Yuden Co., Ltd., Tokyo (JP)

(21) Appl. No.: 12/171,204

(22) Filed: Jul. 10, 2008

(30) Foreign Application Priority Data
Jul. 20, 2007 (JP) 2007-190208

(51) Int. Cl. H01G 4/30; H01G 9/00

(52) U.S. Cl. 361/301.4; 29/25.03

(57) ABSTRACT

A capacitor capable of decoupling in a wide frequency band is obtained. A circuit in which capacitors having different capacitances are combined can be formed without increasing the number of components. Part of a first penetrating electrode or second penetrating electrode is cut by removing a cut portion. A penetrating electrode having a cut portion reduces the number of internal electrodes that are conductively connected, so that a capacitance to be extracted is small. The capacitance to be extracted can be adjusted, depending on which of layers of internal electrodes the cut portion is formed in.

### BACKGROUND OF THE INVENTION

1. Field of the Invention

The present invention relates to a multilayer capacitor having a plurality of capacitances, and a wiring board with a built-in capacitor having a plurality of capacitances.

2. Description of the Related Technology

In recent years, increasing of speeds and higher integration of digital circuits including semiconductor devices such as microprocessors have been progressing. Accordingly, a power-supply high-frequency current that flows in such a digital circuit has increased, thus causing problems such as malfunctions and radiation noise. To solve the problems, a reduction in impedance of a power-supply line, that is, stabilization of the power-supply line by decoupling, is achieved by inserting a capacitor between a power supply of a semiconductor device and the ground.

It is required that the capacitor for use in decoupling operate in a high frequency band. In order for the capacitor to operate in a higher frequency band, the self-resonant frequency (f₀) of the capacitor needs to be higher. Here, the capacitor can be represented by an equivalent circuit in which a capacitance element, an equivalent series inductance (ESL) element, and an equivalent series resistance (ESR) element are connected in series to one another. Since the self-resonant frequency f₀ is represented by f₀=1/[2π×(L×C)^{1/2}], by decreasing an inductance L, that is, ESL, the self-resonant frequency f₀ can be shifted to a higher frequency band.

Examples of capacitors in which the ESL is decreased include the multilayer capacitor disclosed in Japanese Unexamined Patent Application Publication No. 2001-185442. In this capacitor, the directions of currents flowing in internal electrodes are opposite so that generated magnetic fields cancel each other out, whereby a low ESL is realized. In the multilayer capacitor disclosed in Japanese Unexamined Patent Application Publication No. 2001-185442, in the above manner, the self-resonant frequency f₀ is shifted to a higher frequency band, whereby decoupling in the higher frequency band can be performed.

However, although the multilayer capacitor disclosed in Japanese Unexamined Patent Application Publication No. 2001-185442 is disposed between a semiconductor device on the multilayer capacitor and the ground, with a plurality of penetrating electrodes provided therebetween, the multilayer capacitor substantially has a single capacitance. Thus, the width of a frequency band in which decoupling is possible is dependent on frequency characteristics of the multilayer capacitor. Therefore, it is difficult for decoupling to be performed in a wider frequency band.

For performing decoupling in a wider frequency band, as shown in the equivalent circuit diagram shown in FIG. 6, there is a method in which a plurality of capacitors having different capacitances are connected in parallel to one another. Since a self-resonant frequency changes with a capacitance, a circuit is formed in which capacitors whose self-resonant frequencies differ are connected in parallel to one another. According to this method, as shown in the graph shown in FIG. 7, the frequency characteristics of the capacitors are combined, so that decoupling in a wider frequency band can be performed. However, this method has a problem in that the number of components is increased since it is necessary to prepare a plurality of capacitors.

### SUMMARY

Certain inventive aspects disclose a multilayer capacitor that obtains, without increasing the number of components, advantages equivalent to those obtained in the case of using a method in which a plurality of capacitors having different capacitances are connected in parallel to one another, and a wiring board having the multilayer capacitor as a core substrate.

According to an aspect of the present invention, there is provided a multilayer capacitor including: a laminate in which a first internal electrode and a second internal electrode are alternately laminated with a portion of a ceramic dielectric provided therebetween, and in which the first internal electrode and the second internal electrode are embedded in the ceramic dielectric; a plurality of first penetrating electrodes penetrating the laminate in a laminating direction of the first internal electrode and the second internal electrode, the first penetrating electrodes being insulated from the second internal electrode and being connected to the first internal electrode; and a plurality of second penetrating electrodes penetrating the laminate in the direction, the second penetrating electrodes being insulated from the first internal electrode and being connected to the second internal electrode, wherein part of one of the first penetrating electrodes or one of the second penetrating electrodes is cut.

In the multilayer capacitor provided, capacitance generated by one first internal electrode and one second internal electrode is extracted by a pair of one first penetrating electrode and one second penetrating electrode. By employing a structure in which part of the penetrating electrode or the second penetrating electrode, the number of internal electrodes conductively connected to the cut penetrating electrode is divided. Capacitance extracted from a pair of the cut penetrating electrode and one penetrating electrode is divided. The capacitance decreases than that extracted from another pair of penetrating electrodes having no cut portion. The capacitance extracted can be adjusted depending on a position at which one penetrating electrode is cut. This makes it possible for one capacitor to have different capacitances. Therefore, a multilayer capacitor having capacitance of a wideband frequency-to-impedance characteristic can be provided. Accordingly, by inserting the multilayer capacitor according to one inventive aspect in a power-supply line of the semiconductor device, decoupling in a wide frequency band can be performed.

In addition, according to another aspect of the present invention, there is provided a wiring board with a built-in capacitor, in which a wiring layer having an insulating layer and wiring conductors that are alternately laminated is formed on at least one surface of a ceramic substrate having capacitor electrodes embedded therein. The ceramic substrate is similar in structure to the above multilayer capacitor.

In the wiring board with a built-in capacitor, the ceramic substrate that serves a core has a structure in which capacitance generated by one first internal electrode and one second internal electrode is extracted by a pair of one first penetrating electrode and one second penetrating electrode. By employing a structure in which part of the first or second penetrating electrode is cut, the number of internal electrodes that are conductively connected to the cut penetrating electrode is divided. Capacitance to be extracted from a pair of the cut penetrating electrode and one penetrating electrode is divided. The capacitance decreases than that extracted from another pair of penetrating electrodes having no cut portion. The capacitance extracted can be adjusted depending on a position at which one penetrating electrode is cut. This makes it possible for the capacitance extracted from a particular par of penetrating electrodes to differ from capacitance extracted from another pair of penetrating electrodes. This enables formation of a plurality of capacitors having different capacitances on one ceramic substrate. By using a wiring board in which the above ceramic substrate is used as a core substrate, the number of components mounted on the wiring board can be reduced.

According to certain inventive aspects, a capacitor is allowed to have a plurality of different capacitances. Thus, advantages equivalent to those obtained by a circuit in which a plurality of capacitors having different capacitances are connected in parallel can be obtained. Accordingly, a capacitor capable of decoupling in a wide frequency band can be obtained. In addition, capacitance extracted from a particular pair of penetrating electrodes is allowed to differ from that extracted from another pair of penetrating electrodes. Thus, a wiring board with a built-in capacitor in which a circuit formed by combining a plurality of capacitors having different capacitances is formed can be obtained without increasing the number of components.

### BRIEF DESCRIPTION OF THE DRAWINGS

FIG. 1 is a schematic sectional view showing a multilayer capacitor of one embodiment.

FIG. 2 is an exploded, perspective view showing the multilayer capacitor of one embodiment.

FIG. 3 is a perspective view showing an example of the exterior of the multilayer capacitor of one embodiment.

FIG. 4 is a schematic sectional view showing an example of use of the multilayer capacitor of one embodiment.

FIG. 5 is an equivalence circuit diagram corresponding to the schematic sectional view shown in FIG. 4.

FIG. 6 is an equivalent circuit diagram showing a state in which a decoupling capacitor is used.

FIG. 7 is a graph showing frequency-to-impedance characteristics in the equivalent circuit diagram shown in FIG. 6.

FIG. 8 is a schematic sectional view showing another example of use of the multilayer capacitor of one embodiment.

FIG. 9 is an equivalent circuit diagram showing an embodiment corresponding to the graph in FIG. 7.

FIG. 10 is a schematic sectional view showing a wiring board, of one embodiment, having a built-in capacitor.

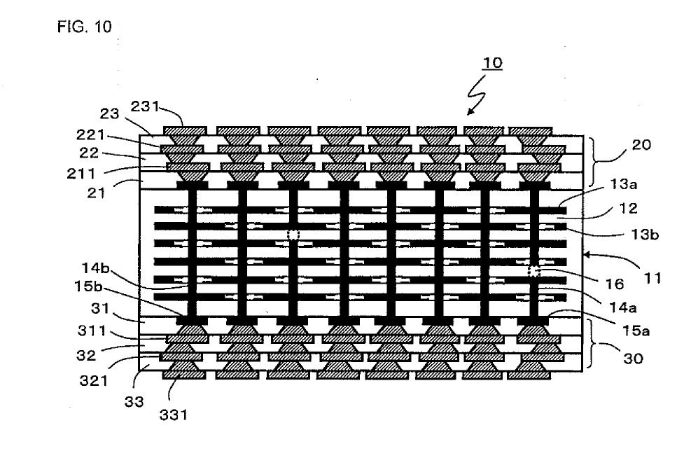

FIG. 11 is a schematic sectional view showing another example of the wiring board, of one embodiment, having a built-in capacitor.

### DETAILED DESCRIPTION OF CERTAIN EMBODIMENTS

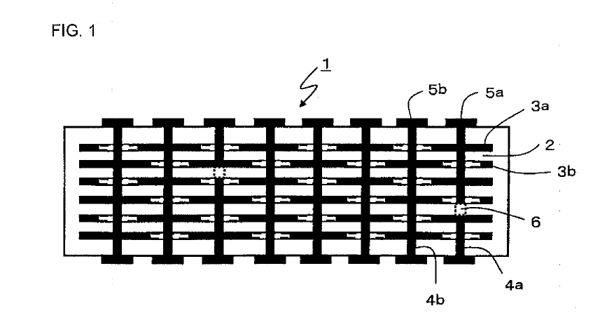

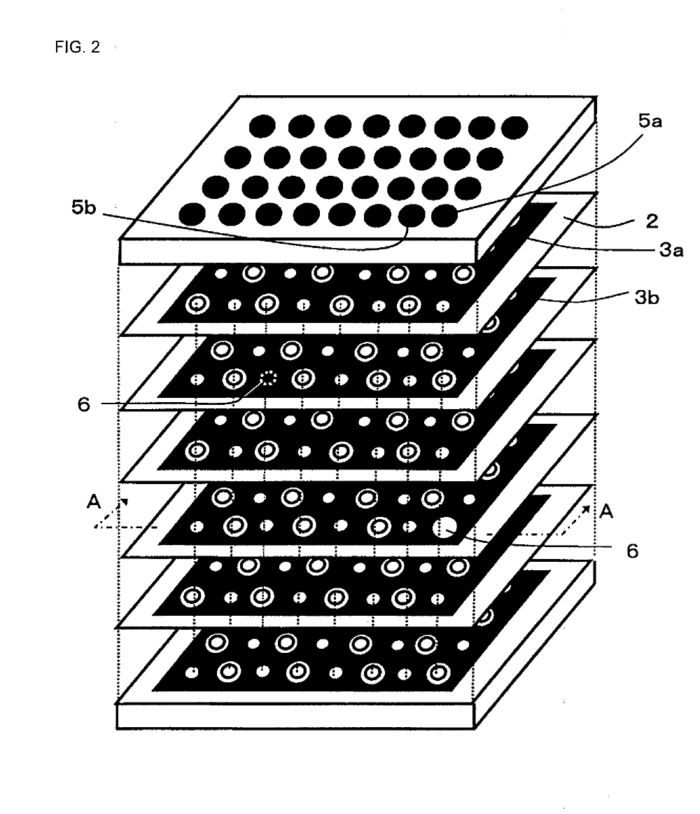

An embodiment of a multilayer capacitor of the present invention will be described with reference to the accompanying drawings. FIG. 1 is a schematic sectional view showing a multilayer capacitor 1 of one embodiment. FIG. 2 is an exploded perspective view of the multilayer capacitor 1 of one embodiment. FIG. 1 shows the section taken along the line A-A.

In the multilayer capacitor 1, first internal electrodes 3a and second internal electrodes 3b are alternately laminated so that each first internal electrode 3a faces a corresponding second internal electrode 3b with a portion of a ceramic dielectric 2 provided therebetween. The laminated first internal electrodes 3a and second internal electrodes 3b are embedded in a laminate composed of the ceramic dielectric 2. To extract capacitance, a plurality of first penetrating electrodes 4a that are formed with through holes penetrating the first internal electrodes 3a and the second internal electrodes 3b in the laminating direction are conductively connected to the first internal electrodes 3a. Similarly, a plurality of second penetrating electrodes 4b that are formed with through holes penetrating the first internal electrodes 3a and the second internal electrodes 3b are conductively connected to the second internal electrodes 3b. The first penetrating electrodes 4a are connected to first terminal electrodes 5a on surfaces of the laminate, and the second penetrating electrodes 4b are connected to second terminal electrodes 5b on the surfaces of the laminate.

Part of at least one first penetrating electrode 4a and/or at least one second penetrating electrode 4b is cut by removing a cut portion 6. In FIG. 1, the rightmost first penetrating electrode 4a, and the third second penetrating electrode 4b from the left have cut portions 6. The penetrating electrodes that have the cut portions 6 reduce the number of internal electrodes that are conductively connected. Thus, capacitance that can be extracted is small. In addition, the capacitance to be extracted can be adjusted, depending on which of layers of internal electrodes the cut portion 6 is formed in. This makes it possible for the multilayer capacitor 1 to have a plurality of capacitances.

As shown in FIG. 2, the multilayer capacitor 1 is formed by laminating, on the ceramic dielectric 2, which has a sheet form, conductive films that become the first internal electrodes 3a or the second internal electrodes 3b, and layers in which through holes that become the first penetrating electrodes 4a or the second penetrating electrodes 4b are formed. Materials for the ceramic dielectric 2 include high-dielectric ceramics such as barium titanate (BaTiO₃) and barium zirconate titanate (BaTiZrO₃), and insulating glass ceramics in which filler such as alumina or silica is dispersed. These materials are mixed with an organic binder to form ceramic slurry. By forming the ceramic slurry into a sheet form by using a doctor blade method or the like, a ceramic green sheet is obtained.

The through hole that becomes the first penetrating electrode 4a or second penetrating electrode 4b is formed by drilling a hole in the ceramic green sheet by using a pin or laser beam machine. Here, drilling is not performed at a position corresponding to each cut portion 6. One first internal electrode 3a and one second internal electrode 3b are formed by using screen printing to apply conductive paste on the ceramic green sheet. Here, simultaneously with formation of a conductive film that becomes an internal electrode, the through hole is filled with conductive paste. A conductive film that becomes the first internal electrode 3a is formed so that the periphery of the through hole that becomes the second penetrating electrode 4b has a space. A conductive film that becomes the second internal electrode 3b is formed so that the periphery of the through hole that becomes the first penetrating electrode 4a has a space. Regarding a ceramic green sheet on which no internal electrode is formed, filling of through holes is only performed. Metals for the internal electrodes and the penetrating electrodes include Ni, Cu, Ag, and Pd. A type of metal is selected depending on a material or the like for the ceramic dielectric.

By laminating and compacting the ceramic green sheets on which the conductive paste is applied, and burning the resultant green sheets, a ceramic laminate in which internal electrodes are embedded is formed. The first terminal electrodes 5a and the second terminal electrodes 5b are formed by applying conductive paste on exposed portions of the first penetrating electrodes 4a and the second penetrating electrodes 4b, and baking the applied paste. Regarding the first terminal electrodes 5a and the second terminal electrodes 5b, after conductive paste is applied before the ceramic laminate is burned, the applied paste may be baked simultaneously with burning of the ceramic base. Metals for the terminal electrodes include Ni, Cu, Ag, and Pd.

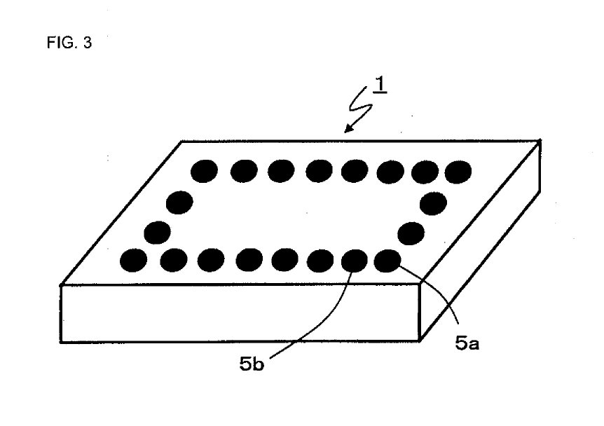

Regarding the arrangement of the terminal electrodes, FIG. 2 shows that the terminal electrodes are arranged in the form of a lattice. However, as shown in FIG. 3, the terminal electrodes may be arranged so as to match the arrangement of terminals of mounted semiconductor devices. Various designs are possible.

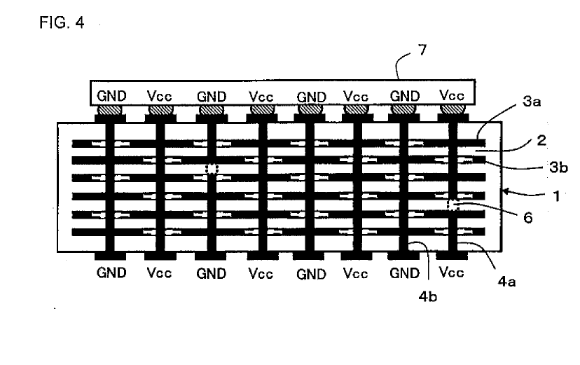

Next, an example of use of the multilayer capacitor 1 of one embodiment will be described. FIG. 4 shows an example in which, by mounting a semiconductor device 7 on the multilayer capacitor 1 shown in FIG. 1, the multilayer capacitor 1 operates as a decoupling capacitor. Power supply terminals Vcc of the semiconductor device 7 are connected to the first terminal electrodes 5a of the multilayer capacitor 1, and ground terminals GND of the semiconductor device 7 are connected to the second terminal electrodes 5b of the multilayer capacitor 1, whereby the first penetrating electrodes 4a serve as power supply lines and the second penetrating electrodes 4b serve as ground lines.

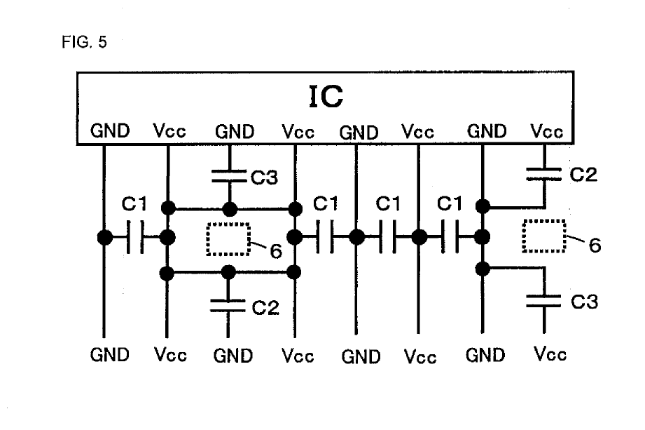

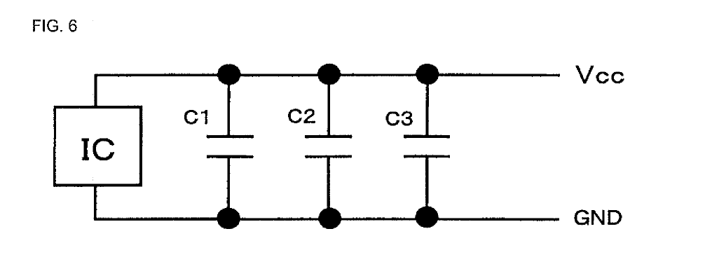

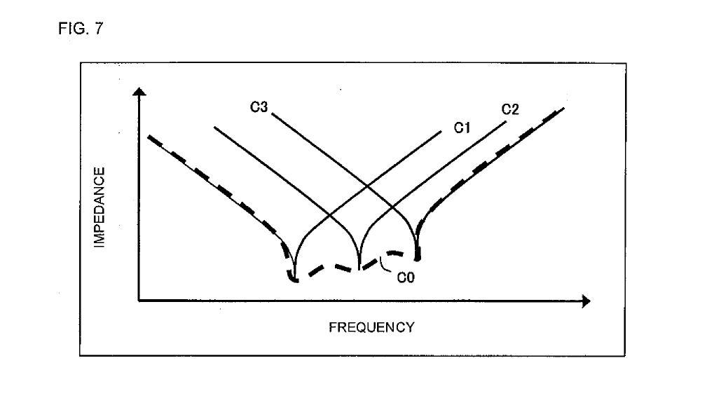

Two cut portions 6 allows the multilayer capacitor 1 to have three types of capacitance. That is, the multilayer capacitor 1 has capacitance C1 generated by six layers of internal electrodes, capacitance C2 generated by four layers of internal electrodes, and capacitance C3 generated by two layers of internal electrodes. This state is represented by the equivalent circuit shown in FIG. 5. Since C1, C2, and C3 are connected in parallel to one another, the equivalent circuit in FIG. 5 is simplified to the circuit diagram shown in FIG. 6. In addition, frequency-to-impedance characteristics of the multilayer capacitor 1 are as shown in FIG. 7.

A self-resonant frequency changes with a capacitance. Thus, the frequency-to-impedance characteristic of C1, the frequency-to-impedance characteristic of C2, and the frequency-to-impedance characteristic of C3 differ. Parallel connection of C1, C2, and C3 combines their frequency-to-impedance characteristics, so that the frequency-to-impedance characteristic of C0, which is indicated by the dotted line, is generated. According to the multilayer capacitor 1 having the frequency-to-impedance characteristic of C0, an impedance can be reduced in a frequency band wider than that in the case of a capacitor having a single capacitance.

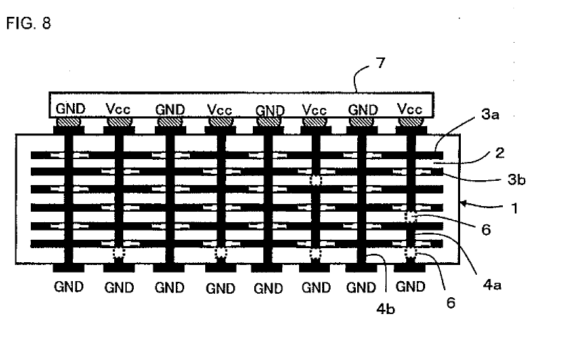

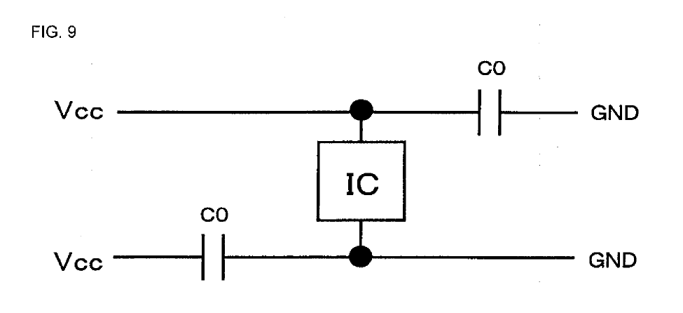

In addition, another example of use of the multilayer capacitor 1 of one embodiment is shown in FIGS. 8 and 9. In the multilayer capacitor 1 shown in FIG. 8, cut portions 6 cut electric connection of all the first penetrating electrodes 4a to the power supply terminals Vcc of the semiconductor device 7. The equivalent circuit of this case is shown in FIG. 9.

This case has a configuration in which the multilayer capacitor 1 is connected in series between the power supply Vcc and the ground GND, so that the multilayer capacitor 1 can be used as an output capacitor for a power supply circuit. Accordingly, the number of components for the output capacitor can be reduced. Regarding the above-described multilayer capacitor 1, one ceramic green sheet of ceramic green sheets on each of which no internal electrodes are formed is processed to form a processed green sheet in which only through holes that become the second penetrating electrodes 4b are formed without forming through holes that become the first penetrating electrodes 4a. By laminating the processed green sheet on a bottom of the multilayer capacitor 1, the above-described multilayer capacitor 1 is obtained.

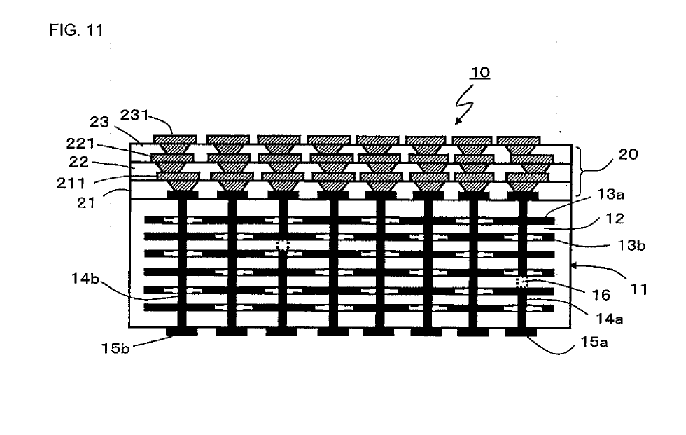

Next, an embodiment of a wiring board having a built-in capacitor, will be described. In the wiring board 10 having a built-in capacitor, a ceramic substrate 11 is used as a core substrate. On a top of the ceramic substrate 11, a wiring layer 20 is formed, and, on a bottom of the ceramic substrate 11, a wiring layer 30 is formed. The wiring layer 20 is formed by sequentially laminating an insulating layer 21, wiring conductors 211, an insulating layer 22, wiring conductors 221, an insulating layer 23, and wiring conductors 231. The wiring layer 30 is formed by sequentially laminating an insulating layer 31, wiring conductors 311, an insulating layer 32, wiring conductors 321, an insulating layer 33, and wiring conductors 331. As shown in FIG. 11, in the wiring board 10, a build-up layer 20 may be formed only on the top of the ceramic substrate 11.

The ceramic substrate 11 is such that a plurality of first capacitor electrodes 13a and a plurality of second capacitor electrodes 13b are alternately laminated so that each first capacitor electrode 13a faces a corresponding second capacitor electrode 13b with a portion of a ceramic dielectric 12 provided therebetween. The laminated first capacitor electrodes 13a and second capacitor electrodes 13b are embedded in a laminate composed of the ceramic dielectric 12. To extract capacitance, a plurality of first penetrating conductors 14a that are formed with through holes penetrating the first capacitor electrodes 13a and the second capacitor electrodes 13b in the laminating direction are conductively connected to the first capacitor electrodes 13a. Similarly, a plurality of second penetrating conductors 14b that are formed with through holes penetrating the first capacitor electrodes 13a and the second capacitor electrodes 13b in the laminating direction are conductively connected to the second capacitor electrodes 13b. The first penetrating conductors 14a are connected to first terminal electrodes 15a on surfaces of the ceramic substrate 11, and the second penetrating conductors 14b are connected to second terminal electrodes 15b on the surfaces of the ceramic substrate 11.

Part of one first penetrating electrode 14a or one second penetrating electrode 14b is cut by removing a cut portion 16. The penetrating electrodes that have the cut portions 16 reduce the number of capacitor electrodes that are conductively connected. Thus, capacitance that can be extracted is small. In addition, the capacitance to be extracted can be adjusted, depending on which of layers of internal electrodes the cut portion 16 is formed in. This makes it possible for the ceramic substrate 11 to have a plurality of capacitances. A material for the ceramic substrate 11, and a method for forming the ceramic substrate 11 are similar to those in the case of the multilayer capacitor 1.

Method for forming the wiring layer 20 and the wiring layer 30 include a method of bonding a prepared wiring board onto the ceramic substrate 11, a method of laminating a ceramic green sheet on which wiring conductors are formed onto a laminate (before being burned) that becomes the ceramic substrate 11 and burning the laminated green sheet, and a build-up method of alternately laminating insulating resin sheets and wiring conductors on the ceramic substrate 11.

In the method of bonding the prepared wiring board onto the ceramic substrate 11, wiring boards that become the wiring layer 20 and the wiring layer 30 are bonded on the ceramic substrate 11 by using an adhesive or the like. Accordingly, materials for the wiring boards are particularly not limited. A wiring board made of resin such as a glass-epoxy resin substrate, and a wiring board made of ceramics such as alumina, glass ceramics, or low-temperature firing ceramics may be used.

In the method of laminating a ceramic green sheet on which wiring conductors are formed onto a laminate (before being burned) that becomes the ceramic substrate 11 and burning the laminated green sheet, a material capable of co-firing with the ceramic dielectric 12 included in the ceramic substrate 11 is selected. For example, a ceramic dielectric having composition substantially similar to that of the ceramic dielectric 12, or ceramics having burning temperature and shrinkage behavior substantially similar to those of the ceramic dielectric 12 is used as an insulating layer. In addition, regarding the wiring conductors, a metal material that is similar to that for the capacitor electrodes embedded in the ceramic substrate 11 is used.

In the build-up method, an existing build-up layer can be formed. On the top of the ceramic substrate 11, the insulating layer 21 is formed, and, on the insulating layer 21, the wiring conductors 211 are formed. Subsequently, the insulating layer 22, the wiring conductors 221, the insulating layer 23, and the wiring conductors 231 are sequentially laminated to form the wiring layer 20. Similarly, on the bottom of the ceramic substrate 11, the wiring layer 30 is formed. Materials for the insulating layers include epoxy resin and polyimide resin. In addition, methods of forming the wiring conductors include a method in which a plating resist is formed in a predetermined pattern, and, after electroless Cu plating or electrolytic Cu plating is used to form a metal layer, the resist is removed, a method in which, after electroless Cu plating or electrolytic Cu plating is used to form a metal layer on the entire surface, etching is used to form the metal layer in a predetermined pattern, and a method in which, after copper foil is bonded, etching is used to form the foil in a predetermined pattern.

The above-described wiring board 10 has types of capacitances. Thus, among electronic components to be mounted, capacitors that have capacitances generated by capacitor electrodes embedded in the ceramic substrate 11 can be reduced. The number of penetrating conductors determines the number of capacitors that are formed in the wiring board 10, and the position of each cut portion 16 determines capacitances.

Certain embodiments of the multilayer capacitor and a wiring board with a built-in capacitor have been described. The present invention is not limited to the above embodiments, and can be altered within the scope of the present invention.

While the above detailed description has shown, described, and pointed out novel features of the invention as applied to various embodiments, it will be understood that various omissions, substitutions, and changes in the form and details of the device or process illustrated may be made by those skilled in the technology without departing from the spirit of the invention. The scope of the invention is indicated by the appended claims rather than by the foregoing description. All changes which come within the meaning and range of equivalency of the claims are to be embraced within their scope.

What is claimed is:

1. A multilayer capacitor comprising:
a laminate in which a first internal electrode and a second internal electrode are alternately laminated with a portion of a ceramic dielectric provided therebetween, and in which the first internal electrode and the second internal electrode are embedded in the ceramic dielectric;
a plurality of first penetrating electrodes penetrating the laminate in a laminating direction of the first internal electrode and the second internal electrode, the first penetrating electrodes being insulated from the second internal electrode and being connected to the first internal electrode; and
a plurality of second penetrating electrodes penetrating the laminate in the laminating direction, the second penetrating electrodes being insulated from the first internal electrode and being connected to the second internal electrode,
wherein at least one of the first penetrating electrodes and/or one of the second penetrating electrodes is cut.

2. A wiring board with a built-in capacitor, in which a wiring layer having an insulating layer and wiring conductors that are alternately laminated is formed on at least one surface of a ceramic substrate, the ceramic substrate comprising:
a laminate in which a first capacitor electrode and a second capacitor electrode are alternately laminated with a portion of a ceramic dielectric provided therebetween, and in which the first capacitor electrode and the second capacitor electrode are embedded in the ceramic dielectric;
a plurality of first penetrating conductors penetrating the laminate in a laminating direction of the first capacitor electrode and the second capacitor electrode, the first penetrating conductors being insulated from the second capacitor electrode and being connected to the first capacitor electrode; and
a plurality of second penetrating conductors penetrating the laminate in the laminating direction, the second penetrating conductors being insulated from the first capacitor electrode and being connected to the second capacitor electrode,
wherein at least one of the first penetrating conductors and/or one the second penetrating conductors is cut.

3. A method of making a multi-layer capacitor, the method comprising:
forming a plurality of ceramic green sheets;
drilling holes through at least a first one of said sheets;
drilling holes through at least a second one of said sheets, wherein the holes through said second sheet are aligned with the holes in said first sheet, and wherein said second sheet has at least one fewer hole than said first sheet;
applying conductive paste to the surface and in drilled holes in at least some of said ceramic green sheets; and
laminating and burning said ceramic green sheets to form a laminated capacitor with at least two internal electrodes on ceramic sheet surfaces and penetrating electrodes through said holes.
